(19) United States
(12) Patent Application Publication
(10) Pub. No.: US 2008/0299860 A1
(43) Pub. Date: Dec. 4, 2008

(54) METHOD OF FABRICATING SMART DISPLAY CARD HAVING LIQUID CRYSTAL DISPLAY UNIT

(76) Inventors: Jae Hee LEE, Incheon (KR); Jung Jae LEE, Incheon (KR)

Correspondence Address: LADAS & PARRY LLP, 224 SOUTH MICHIGAN AVENUE, SUITE 1600, CHICAGO, IL, 60604, US

(21) Appl. No.: 12/122,778

(22) Filed: May 19, 2008

(30) Foreign Application Priority Data
May 31, 2007 (KR) 10-2007-0053395

(51) Int. Cl. G02F 1/1333

(52) U.S. Cl. 445/24

(57) ABSTRACT

The present invention relates to a method of fabricating a smart display card having a liquid crystal display unit. A synthetic resin sheet is punched using a press machine, thus forming a frame. The frame is attached to a transparent synthetic resin base sheet on which a gluing agent is coated. A liquid crystal display unit, an IC chip, a PCB, a CPU, and a thin film battery are attached to the transparent synthetic resin base sheet inside the frame. UV resin is coated inside the frame. A cover sheet is attached to the top surface of the frame. The cover sheet is flattenedly pressed in order to remove bubbles in the UV resin. The base sheet, the frame and the cover sheet are placed on a glass plate and then irradiated with UV in order to cure the UV resin. The base sheet and the cover sheet are separated from the frame. Synthetic resin printed sheets are adhered to the top surface and the underside of the frame using the cured UV resin, thus completing the smart display card.

### BACKGROUND OF THE INVENTION

1. Field of the Invention

The present invention relates to a method of fabricating a smart display card including a liquid crystal display unit, and more particularly, to an invention in which a liquid crystal display unit for display, an IC chip, a PCB, a CPU, a thin film battery, and so on are rapidly cured using UV resin with them being built in a smart display card, thereby increasing the efficiency of the work to the maximum.

2. Background of the Related Art

In general, plastic cards can be used instead of cash like credit cards, cash cards, and traffic cards. A card in which IC chips for recording a large capacity of information are built can be used as a hospital's medical examination card, various membership cards, etc. Plastic cards having various purposes have recently been used widely.

There has recently been developed and commercialized a plastic card including a liquid crystal display unit, enabling a user to check the amount of money charged in the card.

This liquid crystal plastic card has a thickness of 0.8 to 0.9 mm and has components, such as a liquid crystal display unit, an IC chip, a PCB, a CPU, and a thin film battery, built therein. The liquid crystal plastic card must experience a very accurate assembly process.

In the prior art, necessary receiving grooves were formed in a plastic card using the milling machine such as CNC. Components were received in the grooves using an adhesive agent. After the adhesive agent was hardened, a printed sheet was adhered on a surface of the card to thereby complete the plastic card.

However, as in the prior art, if the receiving grooves are formed using the milling machine such as CNC, the work becomes complicated, resulting in generation of a large number of defective components. Further, the curing time of the adhesive agent used to adhere the components is lengthened, thereby significantly degrading the workability. Consequently, the efficiency of the work could not be improved.

### SUMMARY OF THE INVENTION

Accordingly, the present invention has been made in view of the above problems occurring in the prior art, and it is an object of the present invention to provide a method of fabricating a smart display card including a liquid crystal display unit, in which a liquid crystal display unit for display, an IC chip, a PCB, a CPU, a thin film battery, and so on are rapidly cured using UV resin with them being built in a smart display card, thereby increasing the efficiency of the work to the maximum.

To achieve the above object, the present invention provides a method of fabricating a smart display card having a liquid crystal display unit, the method including the steps of: punching a synthetic resin sheet 11 using a press machine in order to form a frame 12; attaching the frame 12 to a transparent synthetic resin base sheet 13 on which a gluing agent 13a is coated; attaching a liquid crystal display unit 14a, an IC chip 14b, a PCB 14c, a CPU 14d, and a thin film battery 14e to the transparent synthetic resin base sheet inside the frame 12, coating UV resin 20 inside the frame 12; attaching a cover sheet 15 made of a transparent synthetic resin to the top surface of the frame 12; flattenedly pressing the cover sheet 15 in order to remove bubbles remaining in the UV resin 20; placing the base sheet 13, the frame 12 within which the UV resin 20 is injected, and the cover sheet 15 on a glass plate and irradiating UV to the cover sheet in order to cure the UV resin 20; separating the base sheet 13 and the cover sheet 15 from the frame 12; and adhering synthetic resin printed sheets 16a, 16b to the top surface and the underside of the frame 12 to which the components are adhered by the cured UV resin 20, thus completing the smart display card.

### BRIEF DESCRIPTION OF THE DRAWINGS

Further objects and advantages of the invention can be more fully understood from the following detailed description taken in conjunction with the accompanying drawings in which:

FIGS. 1a to 1k are perspective views sequentially illustrating a method of fabricating a plastic card in accordance with the present invention; and

FIG. 2 is a perspective view of the plastic card completed using the fabrication method in accordance with the present invention.

### EXPLANATION ON REFERENCE NUMERALS OF MAIN ELEMENTS IN THE DRAWINGS

| | |
|---|---|
| 10: smart display card | 11: synthetic resin sheet |
| 12: frame | 13: base sheet |
| 13a: gluing agent | 14a: liquid crystal display unit |
| 14b: IC chip | 14c: PCB |
| 14e: CPU | 14e: thin film battery |
| 14f: button | 15: cover sheet |
| 16a, 16b: printed sheet | 17a, 17b: coating sheet |
| 18: viewing openings | 20: UV resin |
| 30: ultraviolet lamp | 40: pressure roller |

### DETAILED DESCRIPTION OF THE PREFERRED EMBODIMENT

The present invention will now be described in detail in connection with a specific embodiment with reference to the accompanying drawings.

### Embodiment

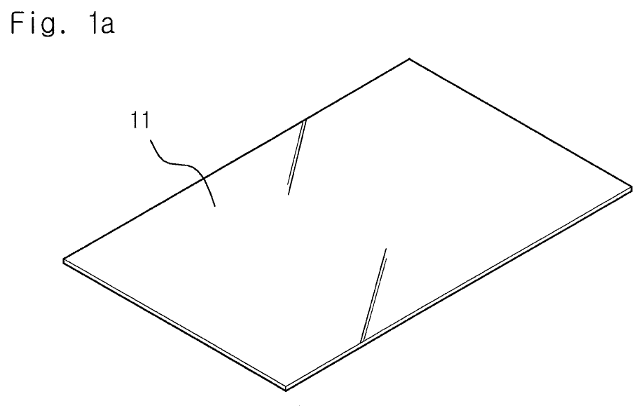

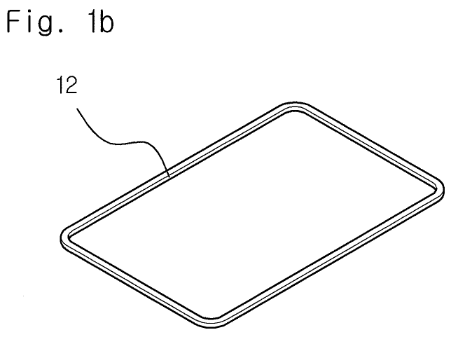

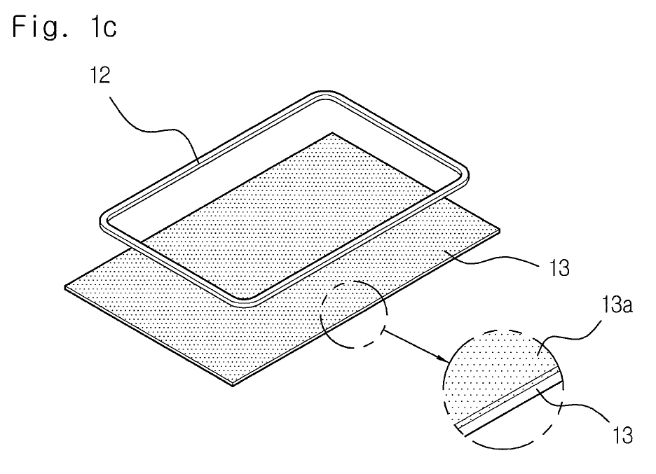

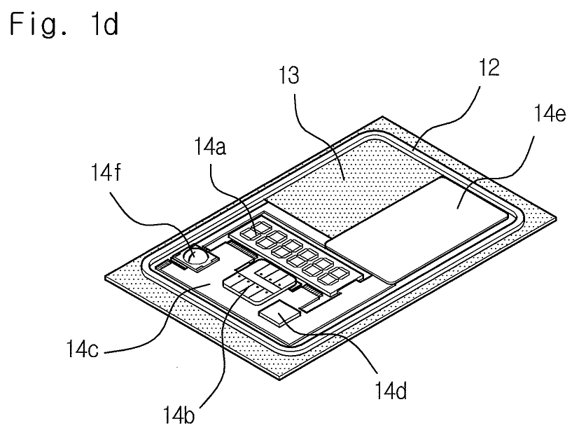

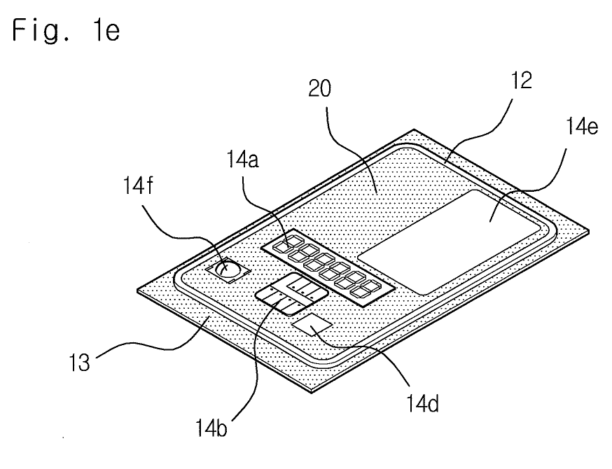

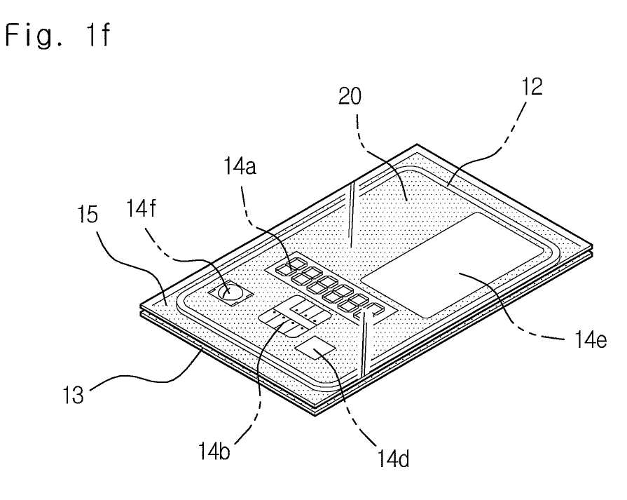

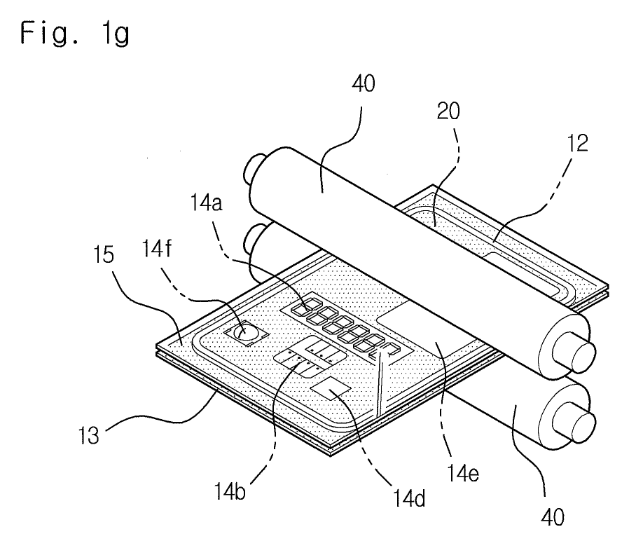

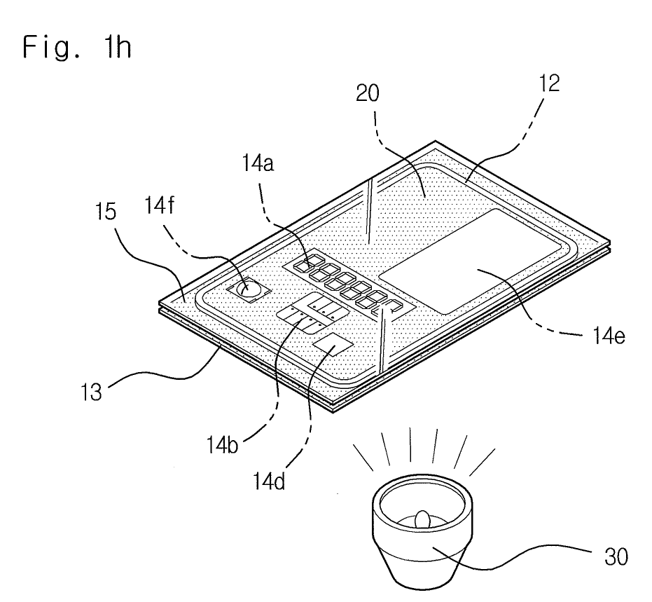

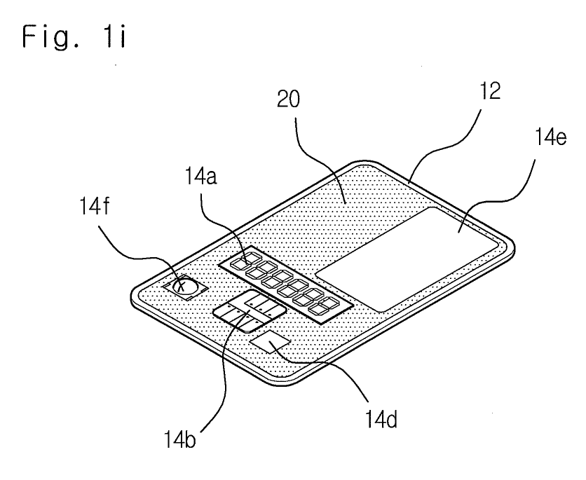

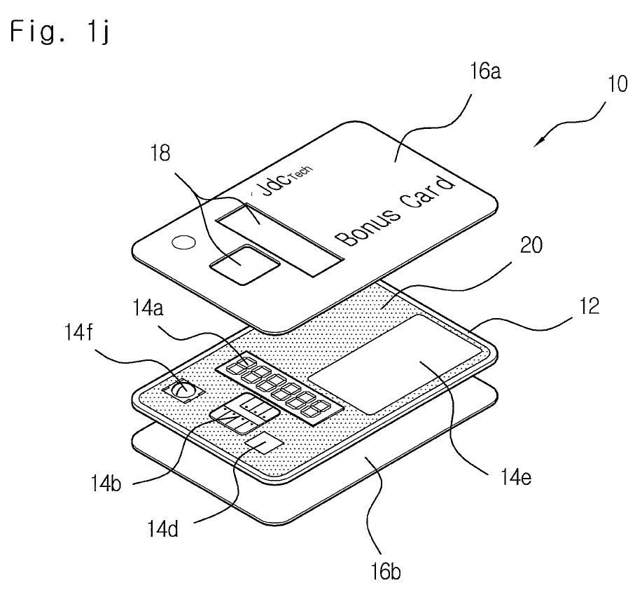

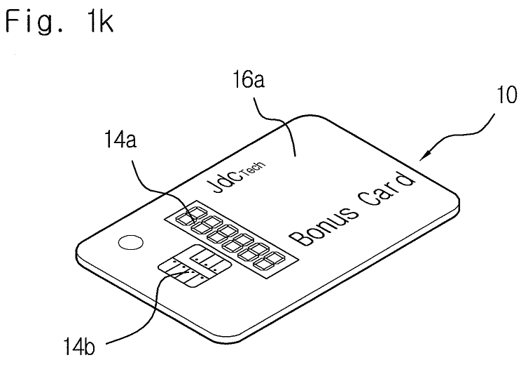

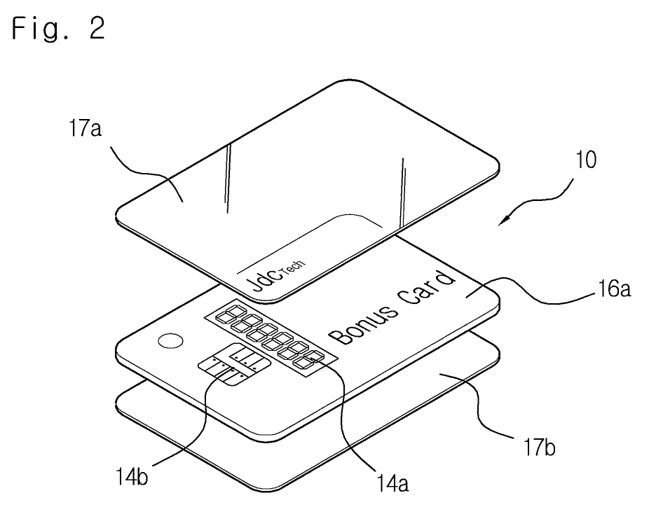

As shown in FIGS. 1 and 2, a synthetic resin sheet 11 is punched by a press machine in order to form a frame 12.

The frame 12 is temporarily attached on a transparent synthetic resin base sheet 13 on which a gluing agent 13a is coated.

The gluing agent 13a employs a UV gluing agent. The UV gluing agent is not cured by UV and can be used to temporarily adhere components.

The base sheet 13 employs a PET sheet that can be easily separated although UV resin is cured.

A liquid crystal display unit 14a, an IC chip 14b, a PCB 14c, a CPU 14d, and a thin film battery 14e are attached inside the frame 12.

The components are indispensable constituent elements for displaying the liquid crystal display unit 14a in a smart display card 10. A combination of the components has already been known and detailed description thereof is omitted.

UV resin 20 is injected and coated inside the frame 12.

A cover sheet 15, that is, a transparent synthetic resin is adhered on the frame 12. Here, the cover sheet 15 employs a PET sheet that can be easily separately although the UV resin is cured.

The cover sheet 15 is then pressed flattenedly in order to remove bubbles remaining in the UV resin 20. The bubbles can be removed by pushing the cover sheet 15 using squeeze employing a silk screen print or having the cover sheet 15 pass through a pair of pressure rollers 40.

Next, the base sheet 13, the frame 12 within which the UV resin 20 is injected, and the cover sheet 15 are placed on a glass plate. In this state, the base sheet 13, the frame 12 and the cover sheet 15 are irradiated with UV using an ultraviolet lamp 30 disposed under the glass plate in order to cure the UV resin 20.

The UV resin 20 is cured for about 10 second or less.

After the curing, the base sheet 13 and the cover sheet 15 are separated from the frame 12.

Synthetic resin printed sheets 16a, 16b are respectively adhered to the top surface and the underside of the frame 12 to which the components are adhered by the cured UV resin 20, thus completing the smart display card.

The printed sheets 16a, 16b are adhered using an adhesive agent for robust adhesion.

As described above, according to the present invention, the synthetic resin sheet 11 is punched by a press machine in order to form the frame 12. The frame 12 is then adhered on the base sheet 13 having the gluing agent 13a coated thereon. Accordingly, receiving grooves necessary for a card can be formed rapidly and conveniently and the failure rate can be minimized, when compared with the conventional technique using a milling machine such as CNC. Further, the components attached inside the frame 12 can be cured in about 10 seconds using the UV curing task employing the UV resin 20. Accordingly, the efficiency of the work can be improved and the processing task of the liquid crystal display unit 14a in the smart display card can be performed simply since the components can be fixed rapidly.

Meanwhile, it has been described that the printed sheets 16a, 16b are adhered to the top surface and the underside of the frame 12, respectively, using an adhesive agent. However, the present invention is not limited to the above method of adhering the printed sheets 16a, 16b to the top surface and the underside of the frame 12, respectively. For example, unlike the above method, after a UV resin is coated on the printed sheets 16a, 16b, the printed sheets 16a, 16b can be adhered to the top surface and the underside of the frame 12 to which the components are fixed, respectively, the printed sheets 16a, 16b can be pressed flattenedly so as to remove bubbles remaining in the UV resin, and the UV resin can be then cured by irradiating UV to the printed sheets in order to fixedly attach the printed sheets 16a, 16b to the top surface and the underside of the frame 12, respectively.

Alternatively, when the upper printed sheet 16a is adhered to the top surface of the frame 12 to which the components are fixed, portions of the upper printed sheet 16a where the liquid crystal display unit 14a and the IC chip 14b are located can be punched in order to form viewing openings 18, or the upper printed sheet 16a can be printed in such a way as to form transparent windows at the portions. Therefore, the liquid crystal display unit 14a can be easily identified through the windows.

Alternatively, transparent coating sheets 17a, 17b can be thermally adhered on and below the upper and lower printed sheets 16a, 16b, respectively, in order to protect the printed surfaces of the upper and lower printed sheets 16a, 16b.

Unexplained reference numeral 14f designates a button for turning on and off the liquid crystal display unit 14a.

As described above, according to the present invention, the synthetic resin sheet 11 is punched by a press machine in order to form the frame 12. The frame 12 is then adhered on the base sheet 13 having the gluing agent 13a coated thereon. Accordingly, there are advantages in that receiving grooves necessary for a card can be formed rapidly and conveniently and the failure rate can be minimized, when compared with the conventional technique using a milling machine such as CNC. Further, the components attached inside the frame 12 can be cured in about 10 seconds using the UV curing task employing the UV resin 20. Accordingly, there is an advantage in that the efficiency of the work can be improved and the processing task of the liquid crystal display unit 14a in the smart display card can be performed simply since the components can be fixed rapidly. Further, there is an advantage in that the present invention can increase competitiveness of the smart display card.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of fabricating a smart display card having liquid crystal display unit, the method comprising the steps of:
punching a synthetic resin sheet 11 using a press machine in order to form a frame 12;
attaching the frame 12 to a transparent synthetic resin base sheet 13 on which a gluing agent 13a is coated;
attaching a liquid crystal display unit 14a, an IC chip 14b, a PCB 14c, a CPU 14d, and a thin film battery 14e to the transparent synthetic resin base sheet inside the frame 12;
coating UV resin 20 inside the frame 12;
attaching a cover sheet 15 made of a transparent synthetic resin to the top surface of the frame 12;
flattenedly pressing the cover sheet 15 in order to remove bubbles remaining in the UV resin 20;
placing the base sheet 13, the frame 12 within which the UV resin 20 is injected, and the cover sheet 15 on a glass plate and irradiating UV the cover sheet in order to cure the UV resin 20;
separating the base sheet 13 and the cover sheet 15 from the frame 12; and
adhering synthetic resin printed sheets 16a, 16b to the top surface and the underside of the frame 12 to which the components are adhered by the cured UV resin 20, thus completing the smart display card.

2. The method as claimed in claim 1, wherein the step of adhering the synthetic resin printed sheets 16a, 16b comprises coating a UV resin on the printed sheets 16a, 16b, adhering the printed sheets 16a, 16b to the top surface and the underside of the frame 12 to which the components are fixed, respectively, flattenedly pressing the printed sheets 16a, 16b so as to remove bubbles remaining in the UV resin, and curing the UV resin by irradiating UV of the printed sheets in order to fixedly attach the printed sheets 16a, 16b to the top surface and the underside of the frame 12, respectively.

3. The method as claimed in claim 1, wherein when the upper printed sheet 16a is adhered to the top surface of the frame 12 to which the components are fixed, portions of the upper printed sheet 16a where the liquid crystal display unit 14a and the IC chip 14b are located are punched in order to form viewing openings 18, or the upper printed sheet 16a is printed in such a way as to form transparent windows at the portions.

4. The method as claimed in claim 1, wherein transparent coating sheets 17a, 17b are thermally adhered to the top surface and the underside of the upper and lower printed sheets 16a, 16b, respectively, in order to protect the printed surfaces of the upper and lower printed sheets 16a, 16b.
